(19) United States
(12) Patent Application Publication
(10) Pub. No.: US 2021/0067088 A1
(43) Pub. Date: Mar. 4, 2021

(54) FRAME FOR A MOBILE SOLAR POWER PANEL SYSTEM

(71) Applicant: Roger Alan Pitcher LE MAISTRE, St. Saviour (JE)

(72) Inventor: Roger Alan Pitcher LE MAISTRE, St. Saviour (JE)

(21) Appl. No.: 17/009,028

(22) Filed: Sep. 1, 2020

(30) Foreign Application Priority Data
Sep. 3, 2019 (GB) 1912635.8

(51) Int. Cl. H02S 30/20; H02S 30/10; H02S 10/40

(52) U.S. Cl. CPC H02S 30/20; H02S 10/40; H02S 30/10

(57) ABSTRACT

A frame for a mobile solar power panel system comprises two sub frames each having a front elongate frame member, a back elongate frame member and an outer side elongate frame member and an inner side elongate frame member. The two inner side elongate frame members are connected to one another by at least one hinge so that the two sub frames are movable between a closed and an open position. When the two sub frames are in the closed position each of the elongate frame members from the one sub frame lies adjacent to its corresponding elongate frame member from the other sub frame, and when in the open position the two inner side elongate frame members will be adjacent one another and the two outer side elongate frame members will be spaced apart from one another and all the elongate frame members from both sub frames are substantially co-planar. The frame also includes a plurality of front legs and a plurality of back legs movable between a closed and an open position. A multi directional front wheel is connected to one of the front legs of each sub frame and a multi directional back wheel is connected to one of the back legs of each sub frame.

This application claims priority from GB Patent application no 1912635.8 A filed on 3 Sep. 2019, the entire contents of which are incorporated herein by reference.

### BACKGROUND OF THE INVENTION

This patent application relates to a frame for a mobile solar power panel system.

Solar power panels systems are well known where a plurality of solar panels are placed in a position to receive direct sunlight in order to generate electricity.

However, these systems are fixed in position and therefore not easily movable and certainly not designed to be packed away for storage when not in use.

The present invention seeks to address this.

### SUMMARY OF THE INVENTION

According to one example embodiment there is provided a frame for a mobile solar power panel system, the frame comprising:
two sub frames each comprised of a front elongate frame member, a back elongate frame member and an outer side elongate frame member and an inner side elongate frame member, wherein the two inner side elongate frame members, one from each sub frame, are connected to one another by at least one hinge so that the two sub frames are thereby connected to one another and are movable between a closed and an open position, wherein when the two sub frames are in the closed position each of the elongate frame members from the one sub frame lies adjacent to its corresponding elongate frame member from the other sub frame, and when in the open position the two inner side elongate frame members will be adjacent one another and the two outer side elongate frame members will be spaced apart from one another and all the elongate frame members from both sub frames are substantially co-planar;
a plurality of front legs connected to the front elongate frame member of each sub frame, wherein one of the front legs on each sub frame is movable between a closed and an open position, wherein when in the closed position, the leg is substantially parallel to the elongate frame member to which it is attached, and when in the open position, the leg is substantially perpendicular to the elongate frame member to which it is attached;
a plurality of back legs connected to the back elongate frame member of each sub frame, wherein one of the back legs on each sub frame is movable between a closed and an open position, wherein when in the closed position, the leg is substantially parallel to the elongate frame member to which it is attached, and when in the open position, the leg is substantially perpendicular to the elongate frame member to which it is attached, wherein the plurality of back legs are longer than the plurality of front legs so that when the two sub frames are in the open position the plane of the sub frames will not be parallel to the ground;
a multi directional front wheel connected to one of the front legs of each sub frame; and
a multi directional back wheel connected to one of the back legs of each sub frame.

### BRIEF DESCRIPTION OF THE DRAWINGS

FIG. 1 shows a frame for a solar power panel system in accordance with an example embodiment in a closed position;

FIG. 2 shows the frame of FIG. 1 in an open position;

FIG. 3 shows the frame of FIG. 1 in a partially open position;

FIG. 4 shows a side view of the frame of FIG. 2 in the open position;

FIG. 5 shows a side view of the frame of FIG. 2 in the open position with the back telescopic legs extended; and

FIG. 6 shows the frame of FIG. 1 holding solar panels in place on the frame.

### DESCRIPTION OF PREFERRED EMBODIMENTS

In the following description, for purposes of explanation, numerous specific details are set forth in order to provide a thorough understanding of an embodiment of the present disclosure. It will be evident, however, to one skilled in the art that the present disclosure may be practiced without these specific details.

Referring to the accompanying Figures, an example frame 10 for a solar power panel system is described.

The frame comprises two sub frames 10a and 10b.

The two sub frames 10a and 10b are each comprised of a front elongate frame member 12a and 12b, a back elongate frame member 14a and 14b, an outer side elongate frame member 16a and 16b and an inner side elongate frame member 18a and 18b.

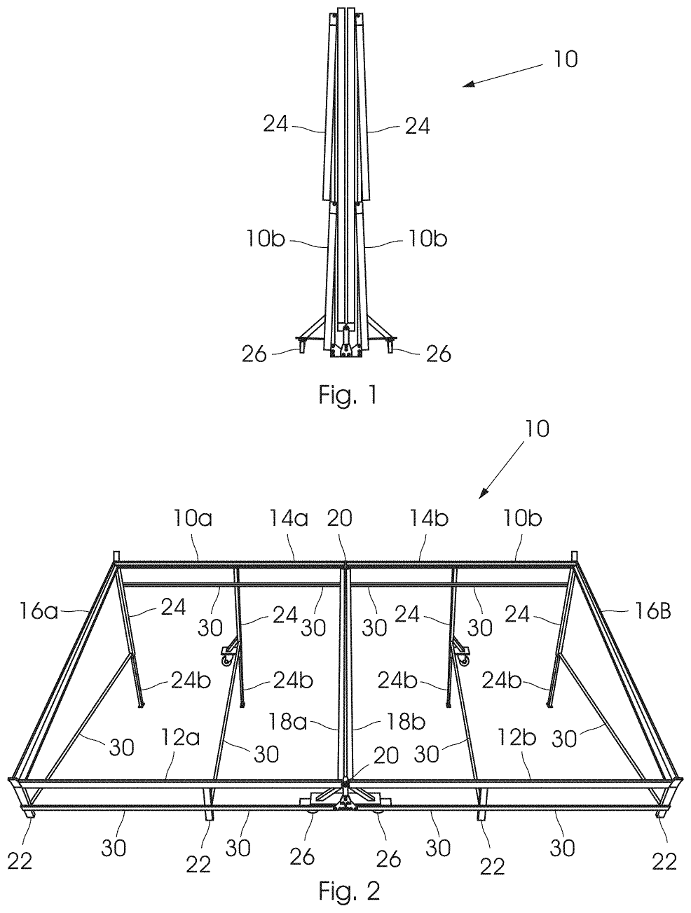

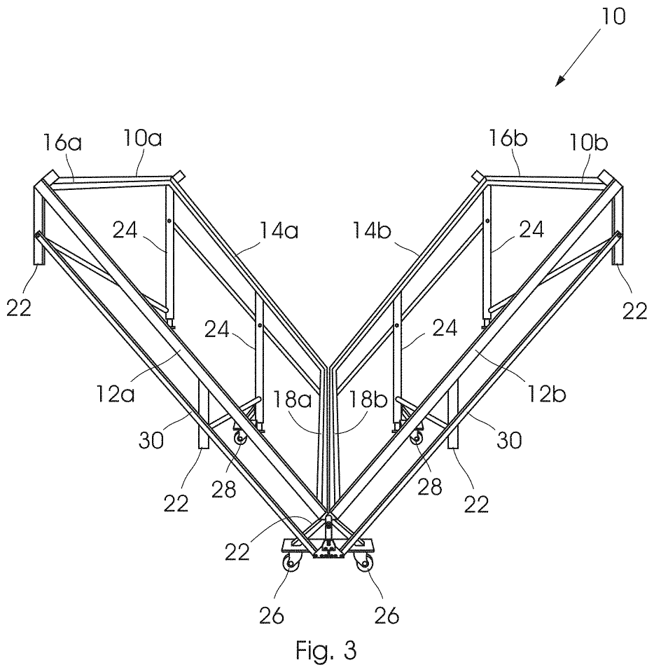

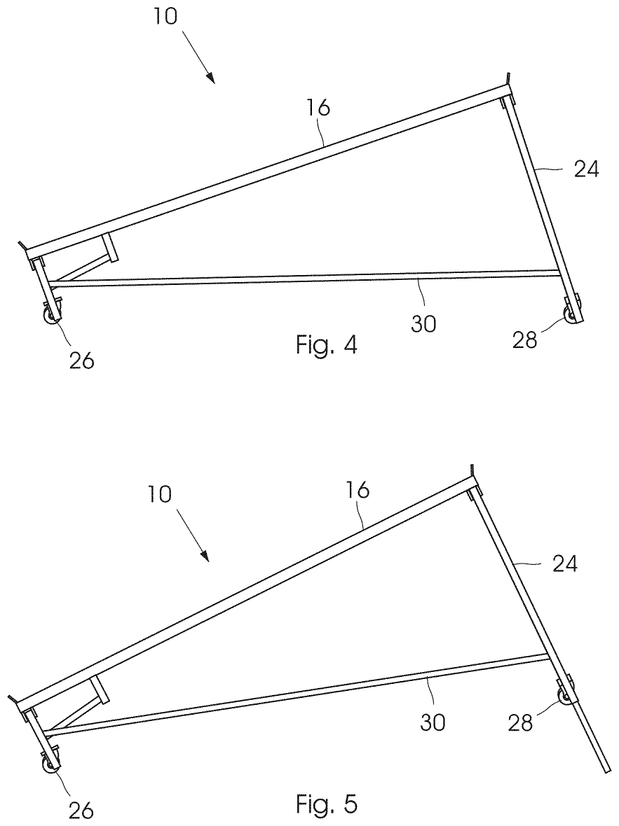

The two inner side elongate frame members 18a and 18b, one from each sub frame, are connected to one another by at least one hinge 20 so that the two sub frames are thereby connected to one another and are movable between a closed position (FIG. 1) and an open position (FIG. 2).

In the prototype embodiment, two hinges 20 were used, one towards each end of the inner side elongate frame members 18a and 18b.

The two hinges 20 are designed to allow the two sub frames 10a and 10b to hinge perfectly so when opened they are abutting and supporting each other.

These hinges are made adequately strong to hold the weight of the whole system as well as the opening forces exerted onto it by the opening of the frame.

When the two sub frames 10a and 10b are in the closed position, each of the elongate frame members from the one sub frame lies adjacent to its corresponding elongate frame member from the other sub frame.

When the two sub frames 10a and 10b are in the open position, the two inner side elongate frame members 18a and 18b are adjacent one another and the two outer side elongate frame members 16a and 16b are spaced apart from one another.

It will be appreciated that in the open position, all the elongate frame members from both sub frames are substantially co-planar.

When the two sub frames 10a and 10b are in the closed position shown in FIG. 1, the two inner side elongate frame members 18a and 18b connected by the at least one hinge 20 are parallel to the ground on which the frame is standing.

These two inner side elongate frame members 18a and 18b are located underneath the two outer side elongate frame members 16a and 16b which are also parallel to the ground on which the frame is standing.

The front elongate frame members 12a and 12b and back elongate frame members 14a and 14b are perpendicular to the floor on which the frame is standing.

At least one front leg 22 is connected to the front elongate frame member 12a and 12b of each sub frame and movable between a closed position (FIG. 1) and an open position (FIG. 2).

When in the closed position, the at least one front leg 22 is substantially parallel to the elongate frame member 12a and 12b to which it is attached, and when in the open position, the at least one front leg 22 is substantially perpendicular to the elongate frame member 12a and 12b to which it is attached.

At least one back leg 24 is connected to the back elongate frame member 14a and 14b of each sub frame and movable between a closed position (FIG. 1) and an open position (FIG. 2).

When in the closed position, the at least one back leg 24 is substantially parallel to the elongate frame member 14a or 14b to which it is attached.

When in the open position, the at least one back leg 24 is substantially perpendicular to the elongate frame member 14a or 14b to which it is attached.

The at least one back legs 24 are longer than the at least one front legs 22 so that when the two sub frames are in the open position, the plane of the sub frames will not be parallel to the ground as can be seen in FIG. 1.

A multi directional front wheel 26 is connected to one of the at least one front legs of each sub frame 10a and 10b.

A multi directional back wheel 28 is connected to one of the at least one back legs of each sub frame.

It will be appreciated that the frame 10 will typically include a plurality of front legs 22 and a plurality of back legs 24 connected to each of the front elongate frame members 12a and 12b and back elongate frame members 14a and 14b respectively.

In the illustrated embodiment, the frame 10 has three front legs 22 on each sub frame, with one of the front legs 22 having a multi directional front wheel 26 connected thereto.

One of the back legs 24 with the multi directional back wheel 28 is attached along the length of the back elongate frame member.

The frame 10 also has extra supporting members 30 running between the front and the back legs and across and parallel to the front and back elongate members as can best be seen in FIG. 2.

Also referring to FIG. 2, the back legs 24 are telescopic in formation. This means that each back leg 24 has an outer piece that is hollow inside and an inner piece 24b that can slide out extending the length of the back leg 24.

It will be appreciated that by extending the length of the back leg 24 the angle of the plane of the sub frames 10a and 10b will be increased with respect to the ground.

It will also be appreciated that when the inner piece 24b extends, the wheel 28 will be lifted off the floor as can be seen in FIG. 2.

When the frame is moved from the closed to the open position, as the two back legs 24 with the multi directional back wheels 28 move from their closed to their open position, the multi directional back wheels 28 roll further away from their starting position relatively closer to the inner side elongate frame members 18a and 18b.

As they roll away they provide support and lift to the back elongate frame members 14a and 14b making the frame very easy to open. This can be seen in FIG. 3 when the frame is shown in a half open position.

The same principle applies in the reverse direction when the frame moves into the closed position.

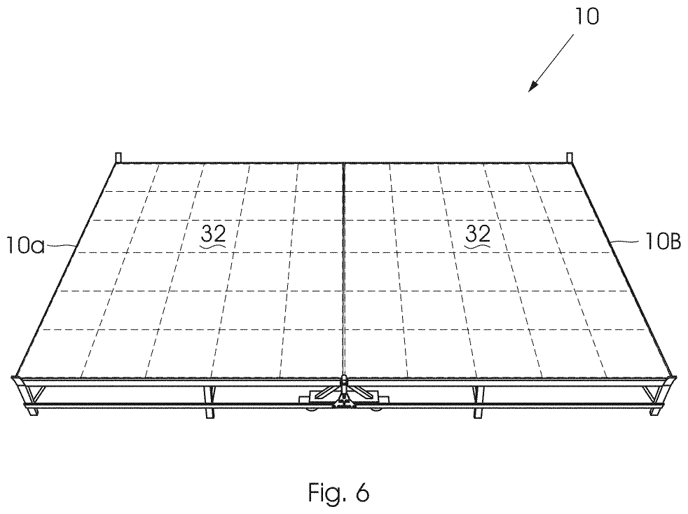

FIG. 6 shows the open frame with solar panels 32 placed on the frame.

Thus it will be appreciated that the frame 10 is designed to support two or more solar modules (including extra-large solar panels) in a vertical plane when not in use or for storage, and in a horizontal/angled plane when opened.

In the closed position the frame 10 rests on the four multi directional wheels 26 and 28 for ease of movement either into storage units or to a location of use.

In the open position the frame 10 rests on the six shorter front legs 22 (two on the wheels 26) and four longer and extendable back legs 24 (two on the wheels 28). These legs 24 automatically deploy when the frame 10 is opened via the hinges connected to the frame and the legs.

The four longer back legs 24 are connected to the corresponding shorter front legs 22 on the opposite end for strength and stability once the frame has been deployed.

The frame 10 is typically made from metal such as angle aluminum, for example, which provides strength and a lower weight.

It will be appreciated that the frame 10 provides something which is easily deployable into position to hold solar panels when in use and which can be closed into a vertical storage position for ease of storage when not in use.

It will be appreciated that when in the closed position, the frame is horizontal to the ground and when in the open position the legs are automatically deployed on both the front and rear sides, and the frame opens to an angled position.

1. A frame for a mobile solar power panel system, the frame comprising:
two sub frames each comprised of a front elongate frame member, a back elongate frame member and an outer side elongate frame member and an inner side elongate frame member, wherein the two inner side elongate frame members, one from each sub frame, are connected to one another by at least one hinge so that the two sub frames are thereby connected to one another and are movable between a closed and an open position, wherein when the two sub frames are in the closed position each of the elongate frame members from the one sub frame lies adjacent to its corresponding elongate frame member from the other sub frame, and when in the open position the two inner side elongate frame members will be adjacent one another and the two outer side elongate frame members will be spaced apart from one another and all the elongate frame members from both sub frames are substantially co-planar;
a plurality of front legs connected to the front elongate frame member of each sub frame, wherein one of the front legs on each sub frame is movable between a closed and an open position, wherein when in the closed position, the leg is substantially parallel to the elongate frame member to which it is attached, and when in the open position, the leg is substantially perpendicular to the elongate frame member to which it is attached;
a plurality of back legs connected to the back elongate frame member of each sub frame, wherein one of the back legs on each sub frame is movable between a closed and an open position, wherein when in the closed position, the leg is substantially parallel to the elongate frame member to which it is attached, and when in the open position, the leg is substantially perpendicular to the elongate frame member to which it is attached, wherein the plurality of back legs are longer than the plurality of front legs so that when the two sub frames are in the open position the plane of the sub frames will not be parallel to the ground;
a multi directional front wheel connected to one of the front legs of each sub frame; and
a multi directional back wheel connected to one of the back legs of each sub frame.

2. A frame according to claim 1 wherein when the two sub frames are in the closed position:
the two inner side elongate frame members connected by the at least one hinge are parallel to the ground on which the frame is standing and are located underneath the two outer side elongate frame members which are also parallel to the ground on which the frame is standing; and
the front elongate frame members and back elongate frame members are perpendicular to the floor on which the frame is standing.

3. A frame according to claim 1 wherein each of the back legs having a multi directional back wheel is attached at a point along the length of the respective back elongate frame member.

4. A frame according claim 1 wherein each of the front legs having a multi directional front wheel is attached at or near a corner joining point of the respective front elongate frame member and the respective inner side elongate frame member.
